(19) United States
(12) Patent Application Publication
(10) Pub. No.: US 2023/0150437 A1
(43) Pub. Date: May 18, 2023

(54) FIXED GLASS ROOF RACK SYSTEM

(71) Applicant: GM GLOBAL TECHNOLOGY OPERATIONS LLC, DETROIT, MI (US)

(72) Inventors: Jesus Anthony Bernal, Farmington Hills, MI (US); Amy Ferris, Mount Pleasant, MI (US); James Joseph Uppleger, Saint Clair Shores, MI (US); Carlos Martinez, LaSalle (CA); John P. O'Brien, Royal Oak, MI (US); Gregory McCurry, South Lyon, MI (US)

(21) Appl. No.: 17/527,312

(22) Filed: Nov. 16, 2021

(51) Int. Cl. B60R 9/052; B62D 25/06

(52) U.S. Cl. CPC B60R 9/052; B62D 25/06

(57) ABSTRACT

A roof and rack assembly for a vehicle includes a roof assembly including a roof panel extending laterally from a first side panel to a second side panel of the vehicle, defining a recess between the each of the first side panel and second side panel, and the roof panel. One or more pedestal brackets are secured to the roof assembly at the recess. A rack assembly includes a pedestal located at each recess and secured to the pedestal bracket, and a crossbar extending between the pedestals and secured thereto.

### INTRODUCTION

The subject disclosure relates to vehicle roof rack systems, and in particular to roof rack systems for a vehicle with a fixed glass roof

In a typical vehicle with a metal roof panel, the roof includes a plurality of stiffeners that extend longitudinally along the roof beneath the roof panel. A typical roof rack has attachment points that engage with the stiffeners to secure the roof rack to the vehicle, and/or includes utilize longitudinally extending rails on each lateral side of the vehicle. Recently, however, vehicles are being developed which have roofs with fixed glass panels, and such roof assemblies do not utilize such roof stiffeners. As such, the art would readily appreciate an effective and aesthetically appealing attachment of roof rack components to vehicles, especially those vehicles having fixed glass roof panels.

### SUMMARY

In one embodiment, a roof and rack assembly for a vehicle includes a roof assembly including a roof panel extending laterally from a first side panel to a second side panel of the vehicle, defining a recess between the each of the first side panel and second side panel, and the roof panel. One or more pedestal brackets are secured to the roof assembly at the recess. A rack assembly includes a pedestal located at each recess and secured to the pedestal bracket, and a crossbar extending between the pedestals and secured thereto.

Additionally or alternatively, in this or other embodiments the pedestal bracket includes a base portion secured to the roof assembly at the recess, and a tab portion extending upwardly from the base portion, the tab portion defining a tab end opening between the tab portion and the base portion.

Additionally or alternatively, in this or other embodiments the pedestal includes opposing end arms that are installed into opposing ends of the tab end opening.

Additionally or alternatively, in this or other embodiments the pedestal includes a tightening mechanism to urge the opposing end arms into the tab end opening.

Additionally or alternatively, in this or other embodiments the opposing end arms rotate about respective arm pivots into the tab end opening.

Additionally or alternatively, in this or other embodiments the pedestal further includes a center leg inserted into an upper tab opening of the pedestal bracket.

Additionally or alternatively, in this or other embodiments the pedestal bracket is secured in the recess via welding.

Additionally or alternatively, in this or other embodiments the roof panel is a fixed glass roof panel.

Additionally or alternatively, in this or other embodiments the roof panel is secured in the roof assembly by an adhesive.

Additionally or alternatively, in this or other embodiments the pedestal includes a crossbar opening into which the crossbar is installed.

In another embodiment, a roof rack attachment apparatus for a vehicle includes a pedestal bracket securable to a roof assembly, the pedestal bracket including a base portion configured for securing to the roof assembly and a tab portion extending upwardly from the base portion. The tab portion defines a tab end opening between the tab portion and the base portion. A pedestal is securable to the pedestal bracket. The pedestal includes opposing end arms that are installed into opposing ends of the tab end opening.

Additionally or alternatively, in this or other embodiments the pedestal includes a tightening mechanism to urge the opposing end arms into the tab end opening.

Additionally or alternatively, in this or other embodiments the opposing end arms rotate about respective arm pivots into the tab end opening.

Additionally or alternatively, in this or other embodiments the pedestal further includes a center leg inserted into an upper tab opening of the pedestal bracket.

Additionally or alternatively, in this or other embodiments the pedestal bracket is secured to the roof assembly via welding.

Additionally or alternatively, in this or other embodiments the tab end opening is substantially C-shaped.

In another embodiment, a method of installing a roof rack to a vehicle roof includes securing two pedestal brackets at opposing lateral sides of a roof assembly of a vehicle. Each pedestal bracket includes a base portion configured for securing to the roof assembly, and a tab portion extending upwardly from the base portion. The tab portion defines a tab end opening between the tab portion and the base portion. A pedestal is installed to each pedestal bracket, and a crossbar is installed to the pedestals to extend between the opposing lateral sides of the roof assembly.

Additionally or alternatively, in this or other embodiments installing the pedestal to each pedestal bracket includes installing opposing end arms of the pedestal into opposing ends of the tab end opening.

Additionally or alternatively, in this or other embodiments the opposing end arms rotate about respective arm pivots into the tab end opening.

Additionally or alternatively, in this or other embodiments a center leg of the pedestal is installed into an upper tab opening of the pedestal bracket.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a perspective view of an embodiment of a roof rack assembly installed to a roof assembly of a vehicle;

FIG. 2 is a plan view of an embodiment roof assembly, viewed from an underside of the roof assembly, showing locations for installation of a roof rack;

FIG. 3 is an illustration of an embodiment of a pedestal bracket installed to a roof assembly;

FIG. 4. is an illustration of an embodiment of a pedestal of a roof rack;

FIG. 5 is a first illustration of installation of an embodiment of a pedestal to a pedestal bracket; and

FIG. 6 is a second illustration of installation of an embodiment of a pedestal to a pedestal bracket.

### DETAILED DESCRIPTION

The following description is merely exemplary in nature and is not intended to limit the present disclosure, its application or uses.

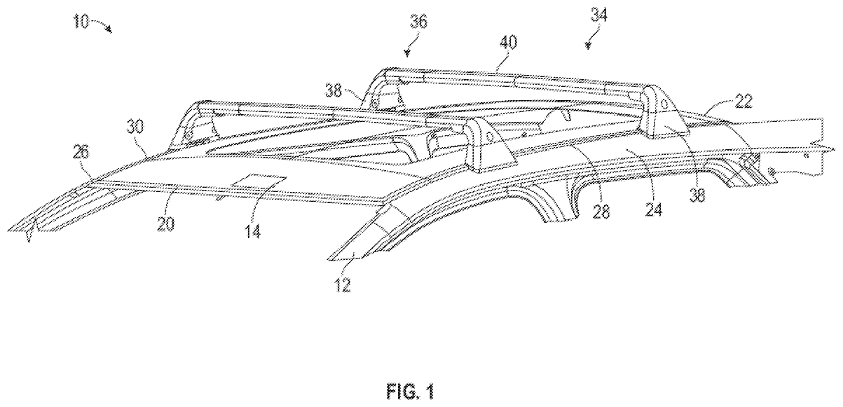

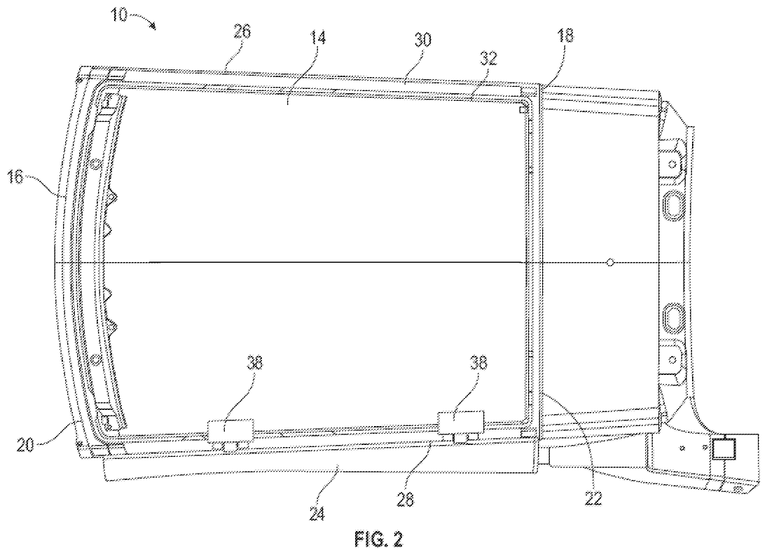

In accordance with an exemplary embodiment, shown in FIGS. 1 and 2 is an embodiment of a roof assembly 10 of a vehicle 12. The roof assembly 10 includes a roof panel 14 formed from glass or other translucent material. The roof panel 14 is secured to a forward stiffener 16 and a rearward stiffener 18, shown in FIG. 2, that each extend laterally across the vehicle 12 at a forward end 20 and a rear end 22, respectively, of the roof panel 14. The roof panel 14 is further secured to a first side panel 24 and a second side panel 26 of the vehicle, located at a first lateral side 28 and a second lateral side 30 of the roof panel 14. In some embodiments, the first side panel 24 and the second side panel 26 are body side outer panels of the vehicle 12. In some embodiments, the roof panel 14 is secured to the stiffeners 16, 18 and the side panels 24, 26 by a bead of adhesive 32 extending around the roof panel 14. The roof assembly 10 may have a rack assembly 34 installed thereto, configured to carry goods on the roof of the vehicle 12, the good including, for example, bicycles, boats, luggage carriers or the like. The rack assembly 34 includes two or more cross bar assemblies 36, with each crossbar assembly 36 having two pedestals 38 secured to the roof assembly 10 and disposed at opposite lateral sides of the roof panel 14, and a crossbar 40 extending between the two pedestals 38. Each pedestal 38 is secured to the roof assembly 10 as will be described below.

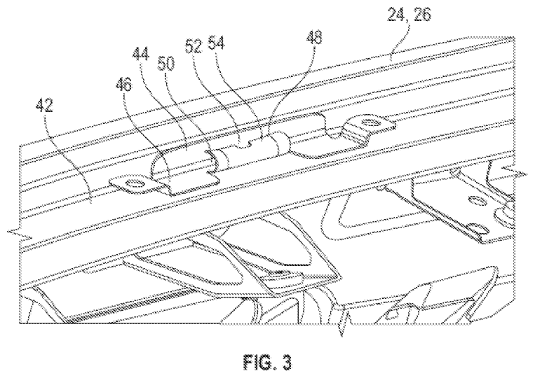

Referring now to FIG. 3, the first side panel 24 and the second side panel 26 each include a panel recess 42 where the roof panel 14 is installed as shown in FIG. 1. The panel recess 42 extends longitudinally along the length of an interface between the roof panel 14 and the side panels 24, 26. A pedestal bracket 44 is secured to the side panel 24, 26 by, for example, welding. The pedestal bracket 44 includes a base portion 46 and a tab portion 48. The tab portion 48 extends upwardly from the base portion 46 and is wrapped or folded to define a tab end opening 50 between the tab portion 48 and the base portion 46. In some embodiments, the tab end opening 50 is substantially C-shaped. Further, the tab portion 48 includes a tab upper opening 52 through a top surface 54 of the tab portion 48 when folded.

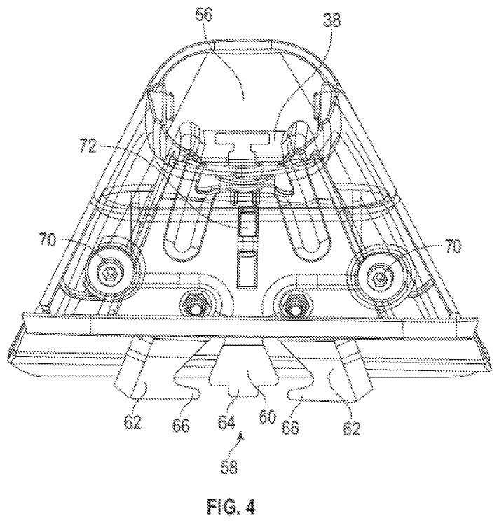

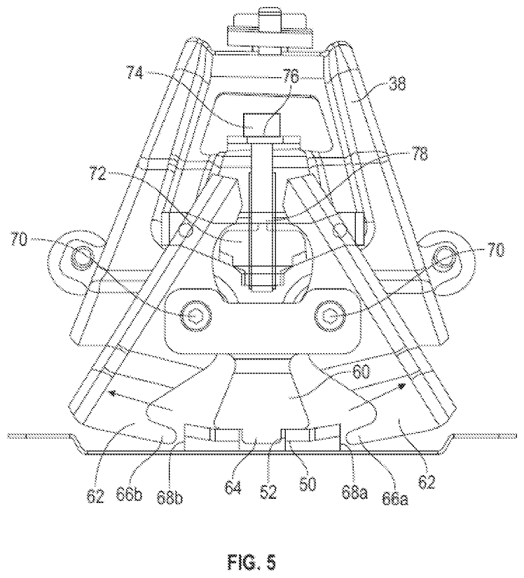

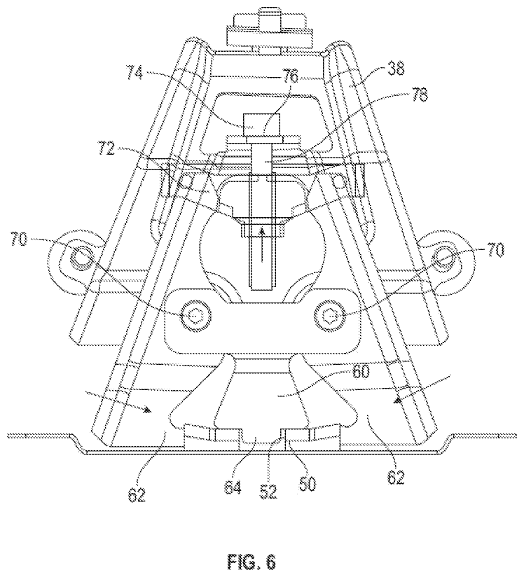

Referring to FIGS. 4, 5 and 6, once the pedestal brackets 44 are secured in the panel recesses 42, each pedestal 38 is installed to a respective pedestal bracket 44. The pedestal 38 includes a crossbar attachment 56 where the crossbar 40 is installed, as illustrated in FIG. 1, and a roof attachment mechanism 58 to secure the pedestal 38 to the roof assembly 10, in particular to secure the pedestal 38 to the respective pedestal bracket 44. The roof attachment mechanism 58 includes a center arm 60 and two opposing end arms 62. The center arm 60 includes a center arm tab 64 that is installed to the tab upper opening 52 of the pedestal bracket 44 to locate the pedestal bracket 44 in a longitudinal direction. The opposing end arms 62 each include an arm finger 66 that are installed into the tab end opening 50 of the pedestal bracket 44. A first arm finger 66a of the first end arm 62a is installed in the tab opening 50 at a first opening end 68a, and a second arm finger 66b of the second end arm 62b is installed in the tab end opening 50 at a second opening end 68b, and the first arm finger 66a and the second arm finger 66b extend substantially toward each other when installed in the tab end opening 50. The end arms 62 are each rotatable about a respective arm pivot 70, and are urged into the tab end opening 50 by a tightening mechanism, which in one exemplary embodiment is a cam 72. As illustrated in FIGS. 5 and 6, the cam 72 is operated by a bolt 74 extending through a bolt opening 76 in the pedestal 38 and into a cam opening 78 in the cam 72. When the bolt 74 is loosened from the cam opening 78, the cam 72 moves downward and urges the end arms 62a, 62b away from the tab end opening 50 by rotation of the end arms 62a, 62b about the arm pivots 70. To engage the end arms 62a, 62b to the pedestal bracket 44, as shown in FIG. 6, the bolt 74 is tightened into the cam opening 78 and the cam 72 moves upward and urges the end arms 62a, 62b into the tab end opening 50 by rotation of the end arms 62a, 62b about the arm pivots 70, thus securing the end arms 62a, 62b to the pedestal bracket 50 by insertion of the arm fingers 66a, 66b into the respective opening ends 68a, 68b.

The use of the pedestal bracket 44 secured to the side panels 24, 26 and the roof attachment mechanism 58 of the pedestal 38 disclosed herein secures the rack assembly 34 to the roof assembly 10 without using the typical longitudinal rails, and the ease of installation of the pedestals 38 avoids a false positive attachment of the pedestal, thereby reducing the possibility of damage to the roof panel 14, which is especially important for vehicles 12 having a roof panel 14 formed from glass.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A roof and rack assembly for a vehicle comprising:
a roof assembly including:
a roof panel extending laterally from a first side panel to a second side panel of the vehicle, defining a recess between the each of the first side panel and second side panel, and the roof panel; and
one or more pedestal brackets secured to the roof assembly at the recess; and
a rack assembly, including:
a pedestal disposed at each recess, the pedestal secured to the pedestal bracket; and
a crossbar extending between the pedestals and secured thereto.

2. The roof and rack assembly of claim 1, wherein the pedestal bracket includes:
a base portion secured to the roof assembly at the recess; and
a tab portion extending upwardly from the base portion, the tab portion defining a tab end opening between the tab portion and the base portion.

3. The roof and rack assembly of claim 2, wherein the pedestal includes opposing end arms that are installed into opposing ends of the tab end opening.

4. The roof and rack assembly of claim 3, wherein the pedestal includes a tightening mechanism to urge the opposing end arms into the tab end opening.

5. The roof and rack assembly of claim 3, wherein the opposing end arms rotate about respective arm pivots into the tab end opening.

6. The roof and rack assembly of claim 2, wherein the pedestal further includes a center leg inserted into an upper tab opening of the pedestal bracket.

7. The roof and rack assembly of claim 1, wherein the pedestal bracket is secured in the recess via welding.

8. The roof and rack assembly of claim 1, wherein the roof panel is a fixed glass roof panel.

9. The roof and rack assembly of claim 8, wherein the roof panel is secured in the roof assembly by an adhesive.

10. The roof and rack assembly of claim 1, wherein the pedestal includes a crossbar opening into which the crossbar is installed.

11. A roof rack attachment apparatus for a vehicle, comprising:
a pedestal bracket securable to a roof assembly, the pedestal bracket including:
a base portion configured for securing to the roof assembly; and
a tab portion extending upwardly from the base portion, the tab portion defining a tab end opening between the tab portion and the base portion; and
a pedestal securable to the pedestal bracket, the pedestal including opposing end arms that are installed into opposing ends of the tab end opening.

12. The roof rack attachment apparatus of claim 11, wherein the pedestal includes a tightening mechanism to urge the opposing end arms into the tab end opening.

13. The roof rack attachment apparatus of claim 11, wherein the opposing end arms rotate about respective arm pivots into the tab end opening.

14. The roof and rack attachment apparatus of claim 11, wherein the pedestal further includes a center leg inserted into an upper tab opening of the pedestal bracket.

15. The roof and rack assembly of claim 11, wherein the pedestal bracket is secured to the roof assembly via welding.

16. The roof assembly of claim 11, wherein the tab end opening is substantially C-shaped.

17. A method of installing a roof rack to a vehicle roof, comprising:
securing two pedestal brackets at opposing lateral sides of a roof assembly of a vehicle, each pedestal bracket including:
a base portion configured for securing to the roof assembly; and
a tab portion extending upwardly from the base portion, the tab portion defining a tab end opening between the tab portion and the base portion;
installing a pedestal to each pedestal bracket; and
installing a crossbar to the pedestals to extend between the opposing lateral sides of the roof assembly.

18. The method of claim 17, wherein installing the pedestal to each pedestal bracket includes installing opposing end arms of the pedestal into opposing ends of the tab end opening.

19. The method of claim 18, wherein the opposing end arms rotate about respective arm pivots into the tab end opening.

20. The method of claim 17, further comprising installing a center leg of the pedestal into an upper tab opening of the pedestal bracket.
